(19) United States
(12) Patent Application Publication
(10) Pub. No.: US 2009/0287517 A1
(43) Pub. Date: Nov. 19, 2009

(54) AUTOMATED METHOD AND SYSTEM FOR OPPORTUNITY ANALYSIS USING MANAGEMENT QUALIFICATION TOOL

(75) Inventor: Kevin M. Hall, (US)

Correspondence Address: ORTIZ & LOPEZ, PLLC, P.O. BOX 4484, ALBUQUERQUE, NM, 87196-4484, US

(73) Assignee: Xerox Corporation

(21) Appl. No.: 12/123,229

(22) Filed: May 19, 2008

(51) Int. Cl. G06F 17/50

(52) U.S. Cl. 705/7

(57) ABSTRACT

An automated method, system and program product for opportunity analysis utilizing a management qualification tool is disclosed. The management qualification tool gathers a current state data concerning a complex business situation and analyzes the data in a stepwise manner through successively detailed questions. A future state solution can be calculated and can be compared to established benchmark data. A report can be automatically generated in a standardized format. Such an approach can be carried out by a software application program associated with a GUI wherein the non-input required fields can be password protected.

### TECHNICAL FIELD

Embodiments are generally related to the field of business development process. Embodiments additionally relate in general to the field of computers and similar technologies, and in particular to software utilized in this field. Embodiments are also related to a management qualification tool.

### BACKGROUND OF THE INVENTION

Modern business enterprises must address issues surrounding the business in a systematic, often time-driven, manner. Such business enterprises typically have an organizational structure to define the various groups of individuals responsible for a particular area of the business. Opportunity analysis is about examining the current situation at any level or levels such as society, organizational, process, or work group to identify the external and internal pressures affecting it. This process will determine the deficiencies or performance gaps that are to be remedied. The output is a statement describing the current state, the projected future state, and the rationale or business case for action or non-action.

Prior art opportunity analysis systems utilize various spreadsheets for capturing a current state data that has to be done manually by different groups. Following physical data collection all data is then typically analyzed by human analysts. Based upon those results a solution set is generated, priced, etc. Often a particular issue evokes different concerns from different groups, resulting in differing definitions of a problem to be addressed. Furthermore, individuals within the groups may not have the knowledge, or expertise, to effectively address a particular problem or decision because of factors such as inexperience or lack of longevity in a particular role. Effectively, addressing the issues presented by such a complex situation, therefore, requires clarification of the exact issues to be acted upon. Each individual may have a different definition of the problem, however, depending on how the complex situation affects the responsibilities of that group and/or individual. The problem associated with such prior art systems is that the whole process can take several weeks and depending on the individuals no two results look the same. Such factors can cause a business enterprise to implement ineffective actions, faulty interpretation and overall data error.

The proliferation of information processing solutions available to a business enterprise has proven advantageous to most modern enterprises, providing an opportunity to apply the benefits of computer processing technology to most every area of the enterprise and accordingly to better service customers in a more efficient manner. Recently, large advances have been made in providing businesses with software solutions covering practically the entire operating environment of a business, including customer and supplier relationship management and supply or value chain management. Such solutions, however, can be complicated and fragmented.

Based on the foregoing a need exists for an improved method and system for opportunity analysis using a simplified and familiar computer software program newly adapted to provide an interactive interface as disclosed in further detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved business development process.

It is a further aspect of the present invention to provide for a method, system and computer-usable medium for opportunity analysis using a computer software program adapted to provide an interactive interface.

The aforementioned aspects and other objectives and advantages can now be achieved as described herein. An automated method, system and program product for opportunity analysis utilizing a management qualification tool is disclosed. The management qualification tool gathers a current state data concerning a complex business situation and analyzes the data in a stepwise manner through successively detailed questions. A future state solution can be calculated and can be compared to established benchmark data. A report can be automatically generated in a standardized format. Such an approach can be carried out by a software application program associated with a GUI wherein the non-input required fields can be password protected.

The management qualification tool can utilize a standard Microsoft Office® application to drive a step by step automated process for gathering data, analyzing the data, and presenting in a clear concise and consistent way the results needed to determine the appropriate solutions. The current state data can be analyzed and rated consistently in a “Scorecard” fashion. All input and output can be locally saved so that various scenarios can be investigated and compared. The software application program includes calculations such as impressions from dollar value given, labor requirements based on inputs of equipment impressions per minute, number of hours needed for finishing, number of shifts and expected utilization of both the equipment and labor.

Furthermore, ROI (return on investment) based on all necessary input can be determined and future ROI based on bringing outsourced volume back can be projected. These calculations can be hidden from the end user and some of them can be actually calculated on hidden worksheets that can be password protected. The software application program can be utilized for healthcare and non-healthcare accounts. The software application program includes a set or sequence of process screen structures through user interaction with the graphical user interface allows entry of data and shows results associated with the data. Such process screen sequences provide a systematic method to gather and organize information effectively in order to determine appropriate solutions.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a functional block diagram of a management qualification system for automatically analyzing and reporting business models, which can be implemented in accordance with invention preferred embodiment;

FIG. 2 illustrates a schematic view of a computer system in which the present invention may be embodied;

FIG. 3 illustrates a schematic view of a software system including an operating system, application software, and a user interface, which can be adapted for use in carrying out an embodiment of the present invention;

FIG. 4 illustrates a detailed flow chart of operations illustrating logical operational steps of a method for opportunity analysis utilizing a qualification management tool, which can be implemented in accordance with a preferred embodiment;

FIG. 5 illustrates an exemplary graphical user interface for beginning a management qualification program, which can be implemented in accordance with a preferred embodiment;

FIG. 6 illustrates an exemplary graphical user interface illustrating management qualification program for healthcare and non-healthcare accounts, which can be implemented in accordance with a preferred embodiment;

FIG. 7 illustrates an exemplary graphical user interface illustrating management qualification program for healthcare accounts, which can be implemented in accordance with a preferred embodiment;

FIG. 8 illustrates an exemplary graphical user interface for gathering current state information, which can be implemented in accordance with a preferred embodiment;

FIG. 9 illustrates an exemplary graphical user interface illustrating site planning cost analysis, which can be implemented in accordance with a preferred embodiment; and

FIG. 10 illustrates an exemplary graphical user interface illustrating benchmark comparison, which can be adapted for use in carrying out an embodiment of the present invention.

### DETAILED DESCRIPTION

The particular values and configurations discussed in these non-limiting examples can be varied and are cited merely to illustrate at least one embodiment and are not intended to limit the scope of such embodiments.

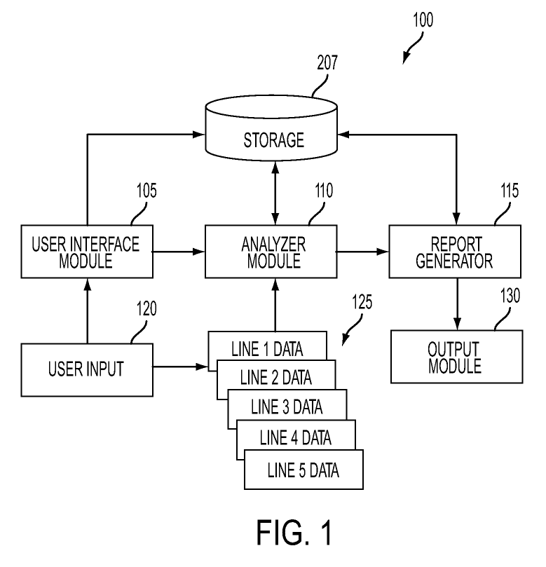

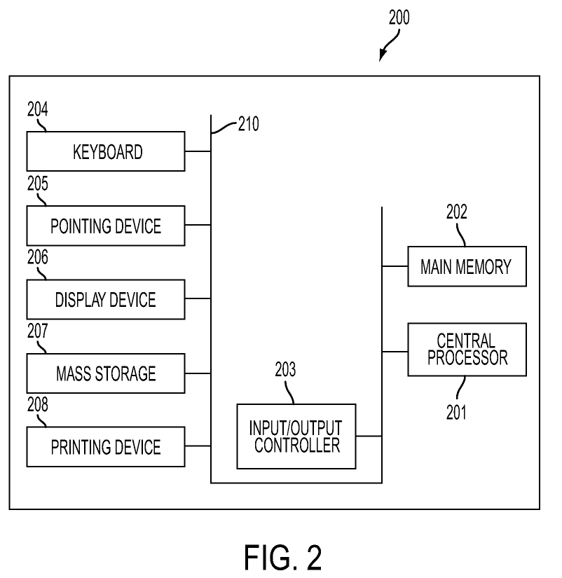

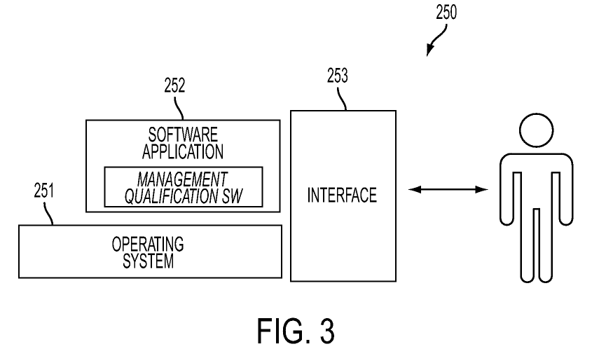

Referring to FIG. 1 a functional block diagram of a management qualification system 100 for automatically analyzing and reporting business models is illustrated, which can be implemented in accordance with invention preferred embodiment. The management qualification system 100 typically includes a user interface module 105, an analyzer module 110, a report generator 115 and an output module 130. In general, the management qualification system 100 can be implemented on a hardware computer system as software modules, as shown in FIG. 3, executable by a digital data processor in the computer system. The user interface module 105 receives a user input 120 through a mouse and keyboard connected to the data-processing apparatus 200 as shown in FIG. 2. The input includes current state information that describes the data, transactions, processes, and architecture for a proposed information system to be used in an organization. Typically, the management qualification system 100 can be used in connection with a business organization, but may also be provided for other types of organizations, such as academic, for profit, nonprofit, government, or other types of organizations.

The analyzer module 110 gather data's 125 from the user through user input 120 and analyze the data's 125 for equipment planning, site planning cost analysis and also predict future state information. Further the analyzer module 110 compares the future state information with the established benchmark data. The report generator 115 generates report in a standardized format which is also password protected and auto-populated programmatically. The extracted information from the user can be stored within an application database 207 as shown in FIG. 2. The application database 207 includes tables for storing user input 120, extracted information and system calculations. The output module 130 provides output to an output device, a network, or a storage device.

FIGS. 2-4 are provided as exemplary diagrams of data-processing environments in which embodiments of the present invention may be implemented. It should be appreciated that FIGS. 2-4 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 2, the present invention may be embodied in the context of a data-processing apparatus 200 comprising a central processor 201, a main memory 202, an input/output controller 203, a keyboard 204, a pointing device 205 (e.g., mouse, track ball, pen device, or the like), a display device 206, and a mass storage 207 (e.g., hard disk). Additional input/output devices, such as a printing device 208, may be included in the data-processing apparatus 200 as desired. As illustrated, the various components of the data-processing apparatus 200 communicate through a system bus 210 or similar architecture.

Illustrated in FIG. 3, a computer software system 250 is provided for directing the operation of the data-processing apparatus 100. Software system 250, which is stored in system memory 202 and on disk memory 207, includes a kernel or operating system 251 and a shell or interface 253. One or more application programs, including the management qualification program, such as application software 252, may be “loaded” (i.e., transferred from storage 207 into memory 202) for execution by the data-processing apparatus 200. The data-processing apparatus 200 receives user commands and data through user interface 253; these inputs may then be acted upon by the data-processing apparatus 200 in accordance with instructions from operating module 251 and/or application module 252.

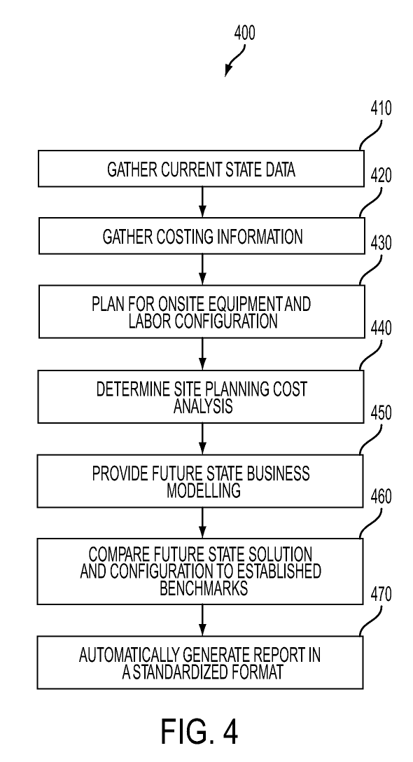

The interface 253, which is preferably a graphical user interface (GUI), also serves to display results, whereupon the user may supply additional inputs or terminate the session. In an embodiment, operating system 251 and interface 253 can be implemented in the context of a Windows®-based system. Window® is a registered trademark of Microsoft Corporation. Application module 252, on the other hand, can include instructions, such as the various operations described herein with respect to the various components and modules described herein, such as, for example, the method 400 depicted in FIG. 4. The management qualification system 100 can be implemented as a software module such as an application module 252. The GUI can be Microsoft Office applications to drive a step by step automated process for gathering data, analyzing same, and presenting in a clear concise and consistent way the results needed to determine the appropriate solutions.

The following description is presented with respect to embodiments of the present invention, which can be embodied in the context of a data-processing system such as data-processing apparatus 200, computer software system 250 depicted respectively FIGS. 2-3. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

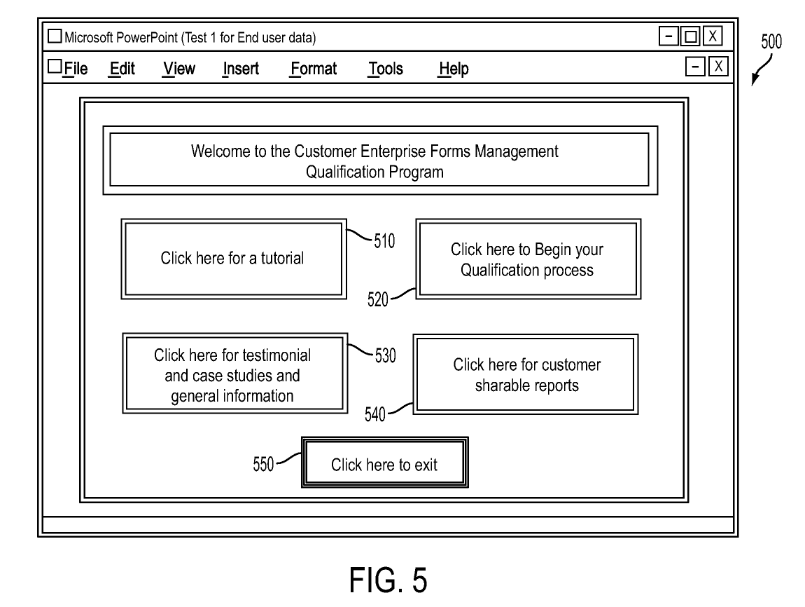

Referring to FIG. 4 a detailed flow chart of operations illustrating logical operational steps of a method 400 for opportunity analysis utilizing a qualification management tool is illustrated, which can be implemented in accordance with a preferred embodiment. Note that the process or method 400 described in FIG. 4 can be implemented in the context of a software module such as application module 252 of computer software system 250 depicted in FIG. 3. A current state data related to a complex business situation can be gathered, as illustrated at block 410. For example, referring to FIG. 5 an exemplary graphical user interface 500 for beginning a management qualification program is illustrated, which can be implemented in accordance with a preferred embodiment.

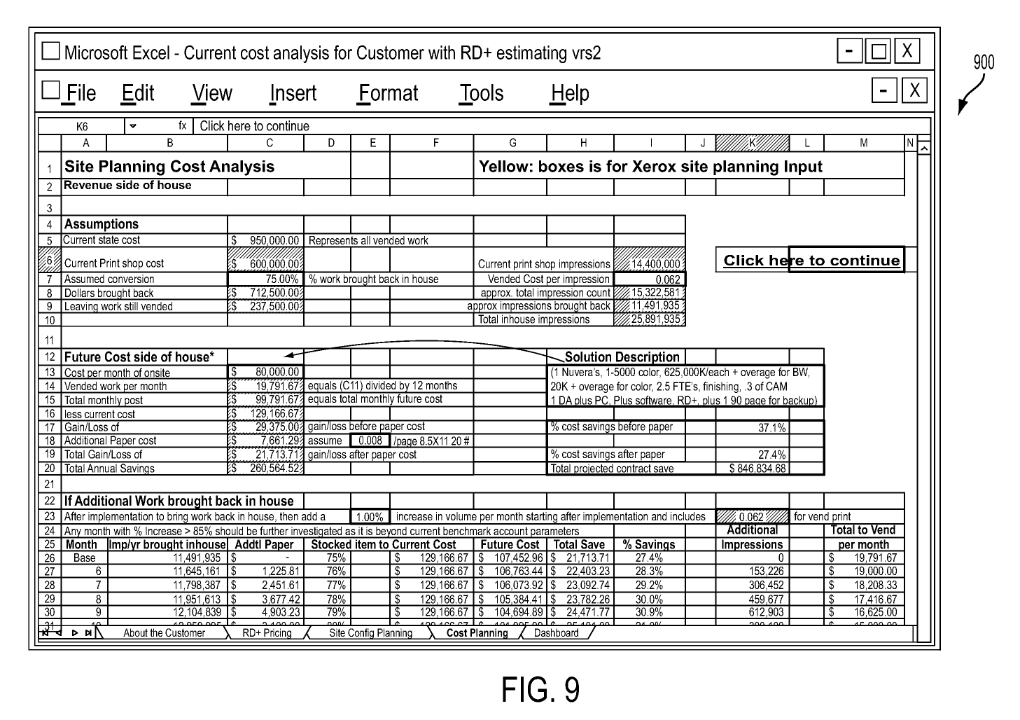

Costing information can be gathered, as shown at block 420. The data can be used for planning onsite equipment and labor configuration, as depicted at block 430. FIG. 9 an exemplary graphical user 900 interface illustrating site planning cost analysis, which can be implemented in accordance with a preferred embodiment. The GUI window 900 gathers costing information regarding future forms management infrastructure. The site planning cost analysis can be determined, as illustrated at block 440. Thereafter, as depicted at block 450, future state business modeling can be provided. The future state solution and configuration can be compared to established benchmarks, as illustrated at block 460. A report can be generated automatically in a standardized format, as depicted at block 470.

It should be appreciated that the particular implementations shown and described in FIGS. 5-10 are merely exemplary and are not intended to limit the scope of the present invention in any way. Referring to FIG. 5, a GUI 500 exemplary of what can be used in the present invention can include word processing and graphic programs, which allow a user to enter information and present it in a visually pleasing manner. Typically, such programs allow the user to present information in a variety of forms without extensive training or specialized knowledge of the software program. Note that the term “GUI” generally refers to a type of environment that represents programs, files, options and so forth by means of graphically displayed icons, menus, and dialog boxes on a computer monitor screen. A user can interact with the GUI 500 to select and activate such options by pointing and clicking with a user input device such as, for example, a pointing device such as a mouse, and/or with a keyboard.

The GUI window 500 includes graphically displayed buttons such as 510, 520, 530 and 540. The user can begin the qualification process by “clicking” the “Click Here to Begin the Qualification Process” button 520. The user can simply exit the GUI window 500 by “clicking” the graphically displayed exit button 550 included within window 500. However, those skilled in the art will recognize that the exemplary GUI window 500 illustrated in FIG. 5 is not intended to limit the present invention. Indeed, those skilled in the art will recognize that other alternative environments may be used without departing from the scope of the present invention. In addition, it should be understood that the present invention may also apply to components other than those disclosed herein.

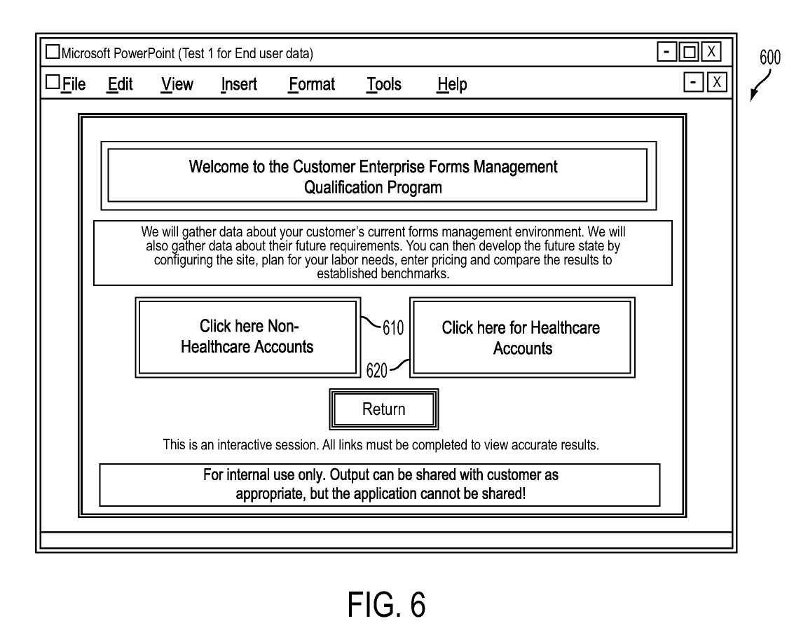

Referring to FIG. 6, illustrated is an exemplary graphical user interface 600 illustrating management qualification program for initiating healthcare and non-healthcare accounts, which can be implemented in accordance with a preferred embodiment. Note that a GUI window 600 as utilized herein generally constitutes a portion of a monitor screen that contains its own document or message. The GUI 600 includes graphically displayed buttons such as 620 and 610 for healthcare and non-healthcare accounts respectively. The user can begin the qualification program for healthcare accounts by “clicking” the “Click Here for healthcare accounts” button 620.

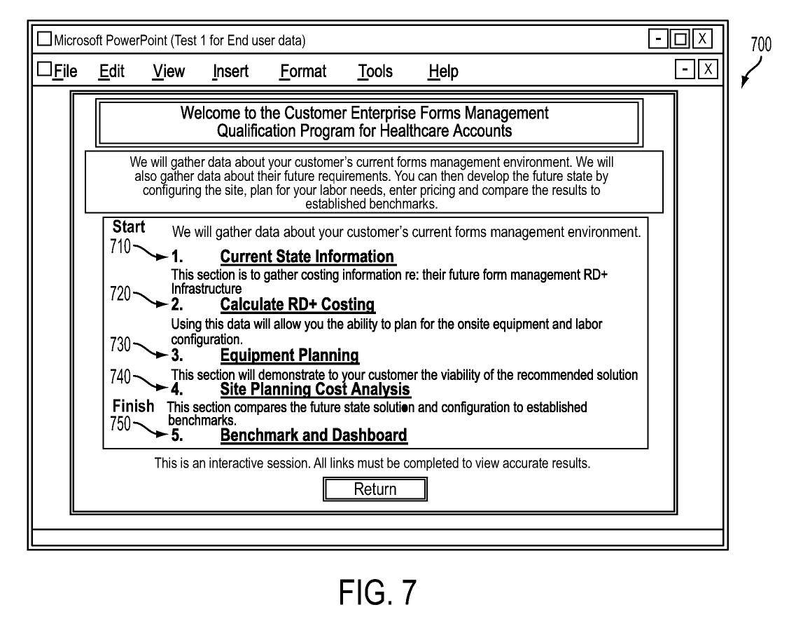

FIG. 7 illustrates an exemplary graphical user interface 700 illustrating management qualification program for healthcare accounts, which can be implemented in accordance with a preferred embodiment. The GUI window 700 include lines such as current state information 710, calculate RD+ costing 720, equipment planning 730, site planning cost analysis 740 and benchmark and dashboard 750 which can be utilized for gathering and analyzing information. The user can click the corresponding line 710-750 for entering data concerning a business situation in a stepwise manner and for analyzing the data and reporting in a standardized format. The user can click on a line item 710-750 from the GUI 700 and an excel screen corresponding to the numbered line can be prompted. By selecting one of these lines 710-750 the user can move to the next GUI window corresponding to the lines 710-750.

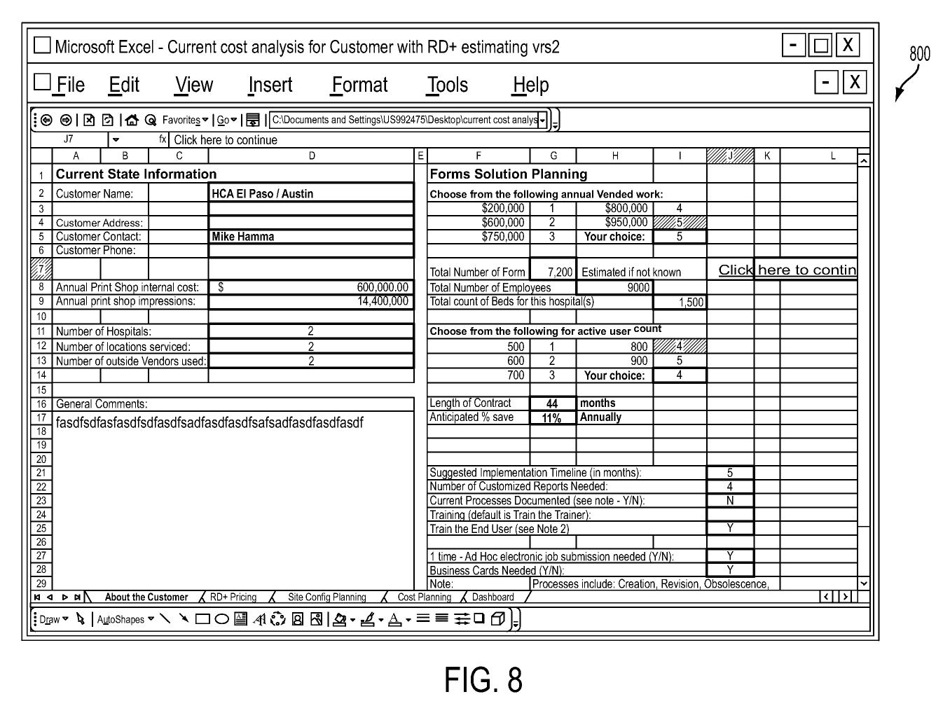

FIG. 8 illustrates an exemplary graphical user interface 800 for gathering current state information 710, which can be implemented in accordance with a preferred embodiment. The GUI window 800 includes spreadsheet which allows the user to enter information that can be analyzed. Such an application permits the creation of lists, reports, charts, tables, graphs and other forms of output. The current state information related to the complex business situation can be entered in the GUI window 800, as shown in FIG. 8. As shown in the GUI window 900 illustrated in FIG. 9, the resulting cost savings to the customer, and the resultant effect of bringing more volume into the print center.

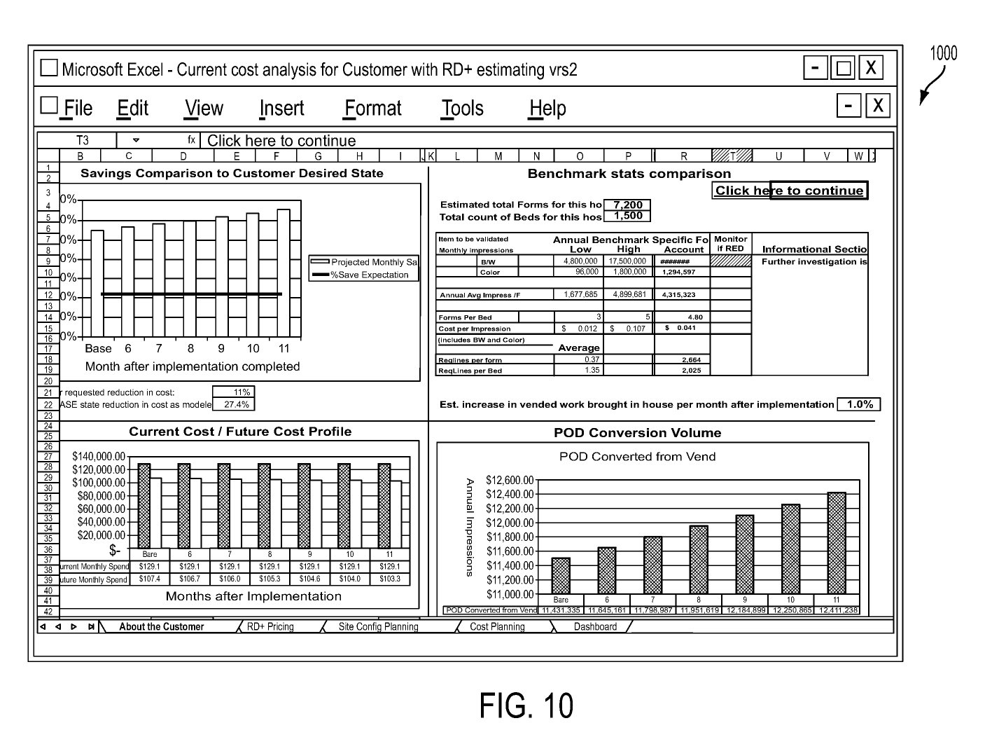

FIG. 10 illustrates an exemplary graphical user interface 950 illustrating benchmark comparison, which can be implemented in accordance with a preferred embodiment. The GUI window 950 illustrates the resultant data and how it compares to benchmarks in the form of charts, tables and graphs.

The current state data can be analyzed and rated consistently in a “Scorecard” fashion. All input and output can be locally saved so that various scenarios can be investigated and compared. The software application program 252 includes calculations such as impressions from dollar value given, labor requirements based on inputs of equipment impressions per minute, number of hours needed for finishing, number of shifts and expected utilization of both the equipment and labor. Further, ROI (return on investment) based on all necessary input can be determined and future ROI based on bringing outsourced volume back can be projected. These calculations are hidden from the end user and some of them are actually calculated on hidden worksheets that are password protected.

Such screens also include some of the criteria used in the calculations that are displayed on the user viewable screens. The hidden screens allow the program to calculate the ReqDirect Plus fees associated with the install and on going maintenance, and another screen assists with calculating the labor requirements for a given installation. The information can be gathered and auto-uploaded to a word template which allows the program to maintain control over the data that is presented and also allows the customer facing documents to be in a standardized format. This method can also be extended to address cross-industry forms data and is easily extensible to data capture of other document processes. Time can be saved because there is no need for administration support to analyze and gather information.

Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent. Thus, the method 400 described herein can be deployed as process software in the context of a computer system or data-processing system as that depicted in FIGS. 2-3, and as exemplified in the screenshots shown in FIGS. 5-10.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data-processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer implemented method for quality analysis, comprising:
gathering a current state information concerning a complex business situation and analyzing said current state information by an analyzer module in a stepwise manner through a plurality of successively detailed questions utilizing a management qualification tool associated with a plurality of GUI windows;
calculating a future state solution and comparing said future state solution against an established benchmark data wherein said future state solution employs a corresponding set of graphical user interface (GUI) windows; and
automatically generating an output report in a standardized format in order to present said output report in a clear concise and consistent way such that said output report determines appropriate solutions for said complex business situation.

2. The computer implemented method of claim 1 wherein said plurality of GUI windows comprises a plurality of input fields and a plurality of non-input fields.

3. The computer implemented method of claim 1 wherein said plurality of non-input fields are password protected.

4. The computer implemented method of claim 1 wherein said plurality of GUI windows is implemented utilizing Microsoft office applications.

5. The computer implemented method of claim 1 further comprising;
determining an ROI based on said plurality of input fields and projecting a future ROI based on bringing outsourced volume associated with complex business situation.

6. The computer implemented method of claim 1 wherein said analyzer module comprises an equipment planning process and a site planning cost analysis process.

7. The computer implemented method of claim 1 wherein said management qualification tool can be implemented as a software application program.

8. A computer implemented method for quality analysis, comprising:
gathering a current state information concerning a complex business situation and analyzing said current state information by an analyzer module in a stepwise manner through a plurality of successively detailed questions utilizing a management qualification tool associated with a plurality of GUI windows further comprising a plurality of input fields and a plurality of non-input fields;
calculating a future state solution and comparing said future state solution against an established benchmark data wherein said future state solution employs a corresponding set of graphical user interface (GUI) windows;
determining an ROI based on said plurality of input fields and projecting a future ROI based on bringing outsourced volume associated with complex business situation; and
automatically generating an output report in a standardized format in order to present said output report in a clear concise and consistent way such that said output report determines appropriate solutions for said complex business situation.

9. The computer implemented method of claim 8 wherein said plurality of non-input fields are password protected.

10. The computer implemented method of claim 8 wherein said plurality of GUI windows is implemented utilizing Microsoft Office® applications.

11. The computer implemented method of claim 8 wherein said analyzer module comprises an equipment planning process and a site planning cost analysis process.

12. The computer implemented method of claim 8 wherein said management qualification tool can be implemented as a software application program.

13. A system for quality analysis, comprising:
a plurality of GUI windows further comprising a plurality of input fields and a plurality of non-input fields adapted to enable a user to interface with the system for quality analysis and an analyzer module;
an analyzer module operable within a computer system and adapted to gather a current state information concerning a complex business situation and analyze said current state information by in a stepwise manner through a plurality of successively detailed questions utilizing a management qualification tool associated with said plurality of GUI windows, said analyzer module further adapted to: calculating a future state solution and comparing said future state solution against an established benchmark data wherein said future state solution employs a corresponding set of graphical user interface (GUI) windows; determining an ROI based on said plurality of input fields and projecting a future ROI based on bringing outsourced volume associated with complex business situation; and automatically generating an output report in a standardized format in order to present said output report in a clear concise and consistent way such that said output report determines appropriate solutions for said complex business situation.

14. The computer implemented method of claim 13 wherein said plurality of non-input fields are password protected.

15. The computer implemented method of claim 13 wherein said plurality of GUI windows is implemented utilizing Microsoft Office® applications.

16. The computer implemented method of claim 13 wherein said analyzer module further comprises an equipment planning process module.

17. The computer implemented method of claim 13 wherein said analyzer module further comprises a site planning cost analysis process.

18. The computer implemented method of claim 13 wherein said management qualification tool can be implemented as a software application program stored on portable media executable on a computer system.

19. The computer implemented method of claim 13 wherein said management qualification tool can be implemented as a software application program stored on a server and accessible by client workstations from said server over a data network.
